(19) United States
(12) Patent Application Publication
(10) Pub. No.: US 2018/0004946 A1
(43) Pub. Date: Jan. 4, 2018

(54) REGULATING CONTROL TRANSFERS FOR EXECUTE-ONLY CODE EXECUTION

(71) Applicant: Intel Corporation, Santa Clara, CA (US)

(72) Inventors: Michael LeMay, Hillsboro, OR (US); Ravi L. Sahita, Portland, OR (US); David M. Durham, Beaverton, OR (US); Scott Dion Rodgers, Hillsboro, OR (US); Vedvyas Shanbhogue, Austin, TX (US)

(73) Assignee: Intel Corporation, Santa Clara, CA (US)

(21) Appl. No.: 15/201,018

(22) Filed: Jul. 1, 2016

(51) Int. Cl. G06F 21/56

(52) U.S. Cl. CPC G06F 21/566; G06F 2221/033; G06F 2221/2143

(57) ABSTRACT

In one embodiment, an apparatus comprises a processor configured to: detect a first control transfer operation; determine that a destination of the first control transfer operation is within code stored in execute-only memory; generate a fault if the destination of the first control transfer operation is an invalid entry point into the code stored in execute-only memory; detect a second control transfer operation while executing the code stored in execute-only memory; and abort execution of the code stored in execute-only memory if the second control transfer operation is detected at an invalid exit point in the code.

### TECHNICAL FIELD

This disclosure relates in general to the field of computer security, and more particularly, to regulating control transfers for execute-only code execution.

### BACKGROUND

Computer systems typically include many different software components, including firmware, operating systems, servers, and applications. Computer systems utilize these software components by executing code associated with each software component. Each software component may include a set of code, and the code set for any given software component may include multiple code segments. Computer systems may utilize control flow operations to transition between different portions of code, for example, from one software component to another, or between different code segments within a single software component.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an example embodiment of a security-enabled network in accordance with the present disclosure.

FIG. 2 illustrates an example embodiment of a client device in accordance with the present disclosure.

FIG. 3 illustrates an example embodiment of a server in accordance with the present disclosure.

FIG. 4 illustrates examples of control-flow enforcement in an execute-only memory environment.

FIG. 5 illustrates a state machine in an example embodiment of control-flow enforcement for execute-only code execution.

FIG. 6 illustrates an example embodiment of using processor instructions for control-flow enforcement for execute-only code execution.

FIG. 7 illustrates an example embodiment of a method of control-flow enforcement for execute-only code execution.

FIG. 8 illustrates an example embodiment of automatically clearing stack data after a stack pop operation.

FIG. 9 illustrates an example embodiment of a method for automatically clearing stack data after a stack pop operation.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Example embodiments of regulating control transfers for execute-only code execution will now be described with more particular reference to the attached FIGURES.

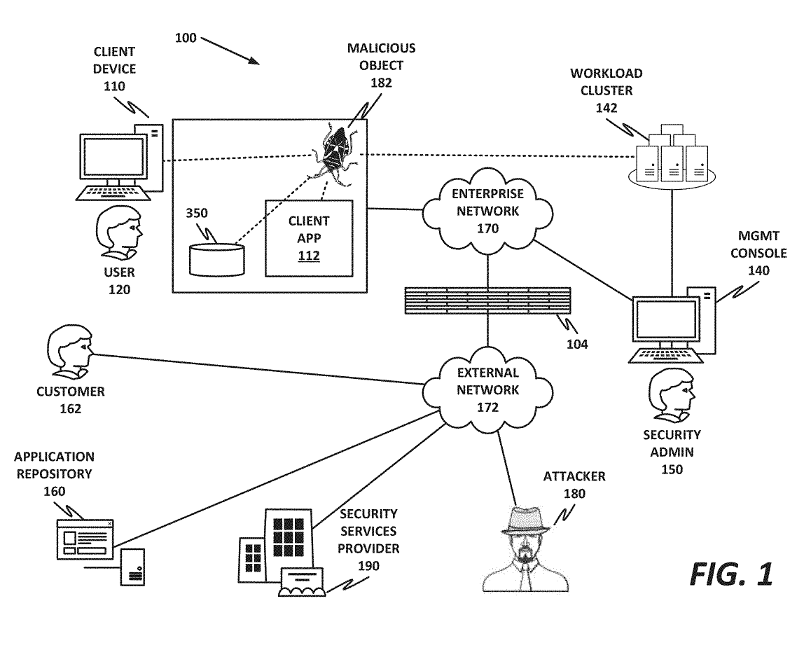

FIG. 1 is a network-level diagram of a secured enterprise 100 according to one or more examples of the present specification. In the example of FIG. 1, secured enterprise 100 may be configured to provide services or data to one or more customers 162, who may access information or services via external network 172. This may require secured enterprise 100 to at least partly expose certain services and networks to the outside world, thus creating a logical security aperture.

In some embodiments, various computing entities in secured enterprise 100 (e.g., client device 110, workload cluster 142, security services provider 190, management console 140, application repository 160) may be implemented with control transfer regulation for execute-only code execution, as described in more detail with respect to the other FIGURES.

Within secured enterprise 100, one or more users 120 operate one or more client devices 110. Each device may include an appropriate operating system, such as Microsoft Windows, Linux, Android, Mac OSX, Apple iOS, Unix, or similar. Some of the foregoing may be more often used on one type of device than another. For example, desktop computers or engineering workstation may be more likely to use one of Microsoft Windows, Linux, Unix, or Mac OSX. Laptop computers, which are usually a portable off-the-shelf device with fewer customization options, may be more likely to run Microsoft Windows or Mac OSX. Mobile devices may be more likely to run Android or iOS. However, these examples are not intended to be limiting.

Client devices 110 may be communicatively coupled to one another and to other network resources via enterprise network 170. Enterprise network 170 may be any suitable network or combination of one or more networks operating on one or more suitable networking protocols, including for example, a local area network, an intranet, a virtual network, a wide area network, a wireless network, a cellular network, or the Internet (optionally accessed via a proxy, virtual machine, or other similar security mechanism) by way of non-limiting example. Enterprise network 170 may also include one or more servers, firewalls, routers, switches, security appliances, antivirus servers, or other useful network devices, which in an example may be virtualized within workload cluster 142. In this illustration, enterprise network 170 is shown as a single network for simplicity, but in some embodiments, enterprise network 170 may include a large number of networks, such as one or more enterprise intranets connected to the internet. Enterprise network 170 may also provide access to an external network, such as the Internet, via external network 172. External network 172 may similarly be any suitable type of network.

A workload cluster 142 may be provided, for example as a virtual cluster running in a hypervisor on a plurality of rack-mounted blade servers, or as a cluster of physical servers. Workload cluster 142 may provide one or more server functions, or one or more “microclouds” in one or more hypervisors. For example, a virtualization environment such as vCenter may provide the ability to define a plurality of “tenants,” with each tenant being functionally separate from each other tenant, and each tenant operating as a single-purpose microcloud. Each microcloud may serve a distinctive function, and may include a plurality of virtual machines (VMs) of many different flavors, including agentful and agentless VMs.

It should also be noted that some functionality of endpoint devices 110 may also be provided via workload cluster 142. For example, one microcloud may provide a remote desktop hypervisor such as a Citrix workspace, which allows users 120 operating endpoints 110 to remotely login to a remote enterprise desktop and access enterprise applications, workspaces, and data. In that case, endpoint 110 could be a “thin client” such as a Google Chromebook, running only a stripped-down operating system, and still provide user 120 useful access to enterprise resources.

One or more computing devices configured as a management console 140 may also operate on enterprise network 170. Management console 140 may provide a user interface for a security administrator 150 to define enterprise security policies, which management console 140 may enforce on enterprise network 170 and across client devices 110 and workload cluster 142. In an example, management console 140 may run a server-class operating system, such as Linux, Unix, or Windows Server. In other case, management console 140 may be provided as a web interface, on a desktop-class machine, or via a VM provisioned within workload cluster 142.

Secured enterprise 100 may encounter a variety of “security objects” on the network. A security object may be any object that operates on or interacts with enterprise network 170 and that has actual or potential security implications. In one example, security objects may be broadly divided into hardware objects, including any physical device that communicates with or operates via the network, and software objects. Software objects may be further subdivided as “executable objects” and “static objects.” Executable objects include any object that can actively execute code or operate autonomously, such as applications, drivers, programs, executables, libraries, processes, runtimes, scripts, macros, binaries, interpreters, interpreted language files, configuration files with inline code, embedded code, and firmware instructions by way of non-limiting example. A static object may be broadly designated as any object that is not an executable object or that cannot execute, such as documents, pictures, music files, text files, configuration files without inline code, videos, and drawings by way of non-limiting example. In some cases, hybrid software objects may also be provided, such as for example a word processing document with built-in macros or an animation with inline code. For security purposes, these may be considered as a separate class of software object, or may simply be treated as executable objects.

Secured enterprise 100 may communicate across enterprise boundary 104 with external network 172. Enterprise boundary 104 may represent a physical, logical, or other boundary. External network 172 may include, for example, websites, servers, network protocols, and other network-based services. In one example, an application repository 160 is available via external network 172, and an attacker 180 (or other similar malicious or negligent actor) also connects to external network 172. A security services provider 190 may provide services to secured enterprise 100.

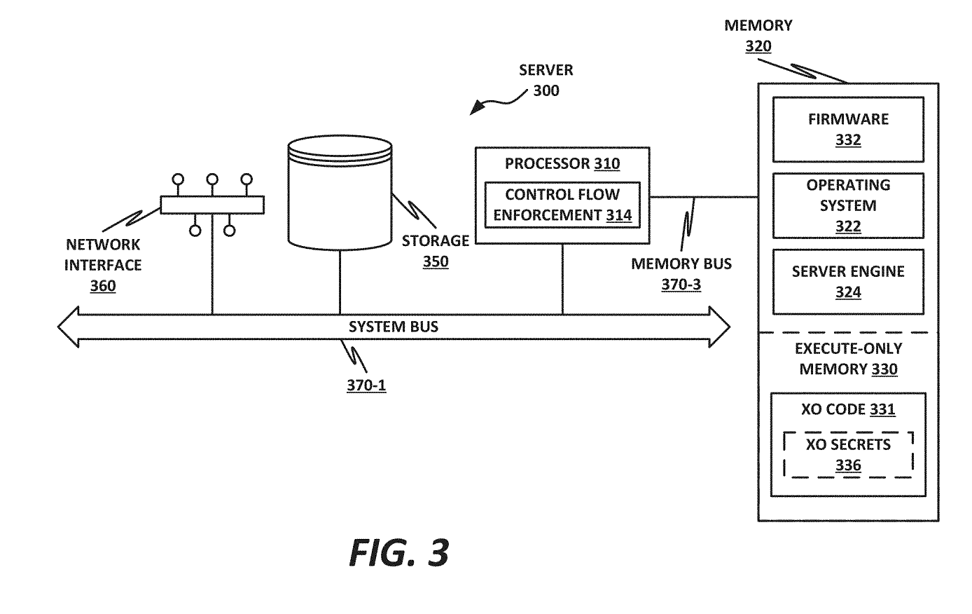

It may be a goal of users 120 and secure enterprise 100 to successfully operate client devices 110 and workload cluster 142 without interference from attacker 180 or from unwanted security objects. In one example, attacker 180 is a malware author whose goal or purpose is to cause malicious harm or mischief, for example by injecting malicious object 182 into client device 110. Once malicious object 182 gains access to client device 110, it may try to perform work such as social engineering of user 120, a hardware-based attack on client device 110, modifying storage (e.g., storage 350 of FIG. 3), modifying client application 112 (which may be running in memory), or gaining access to enterprise servers 142.

The malicious harm or mischief may take the form of installing rootkits or other malware on client devices 110 to tamper with the system, installing spyware or adware to collect personal and commercial data, defacing websites, operating a botnet such as a spam server, or simply to annoy and harass users 120. Thus, one aim of attacker 180 may be to install his malware on one or more client devices 110. As used throughout this specification, malicious software (“malware”) includes any security object configured to provide unwanted results or do unwanted work. In many cases, malware objects will be executable objects, including by way of non-limiting examples, viruses, Trojans, zombies, rootkits, backdoors, worms, spyware, adware, ransomware, dialers, payloads, malicious browser helper objects, tracking cookies, loggers, or similar objects designed to take a potentially-unwanted action, including by way of non-limiting example data destruction, covert data collection, browser hijacking, network proxy or redirection, covert tracking, data logging, keylogging, excessive or deliberate barriers to removal, contact harvesting, and unauthorized self-propagation.

Attacker 180 may also want to commit industrial or other espionage against secured enterprise 100, such as stealing classified or proprietary data, stealing identities, or gaining unauthorized access to enterprise resources. Thus, attacker 180's strategy may also include trying to gain physical access to one or more client devices 110 and operating them without authorization, so that an effective security policy may also include provisions for preventing such access.

In another example, a software developer may not explicitly have malicious intent, but may develop software that poses a security risk. For example, a well-known and often-exploited security flaw is the so-called buffer overflow, in which a malicious user is able to enter an overlong string into an input form and thus gain the ability to execute arbitrary instructions or operate with elevated privileges on a computing device. Return-oriented programming (ROP), and similarly call/jmp-oriented programming (COP/JOP), are computer security exploit techniques that allow attackers 180 to leverage buffer overflow vulnerabilities to execute malicious sequences of code by overwriting the return address on the stack. Buffer overflows may be the result, for example, of poor input validation or use of insecure libraries, and in many cases arise in nonobvious contexts. Thus, although not malicious, a developer contributing software to application repository 160 may inadvertently provide attack vectors for attacker 180.

Poorly-written applications may also cause inherent problems, such as crashes, data loss, or other undesirable behavior. Because such software may be desirable itself, it may be beneficial for developers to occasionally provide updates or patches that repair vulnerabilities as they become known. However, from a security perspective, these updates and patches are essentially new objects that must themselves be validated.

Application repository 160 may represent a Windows or Apple “App Store” or update service, a Unix-like repository or ports collection, or other network service providing users 120 the ability to interactively or automatically download and install applications on client devices 110. If application repository 160 has security measures in place that make it difficult for attacker 180 to distribute overtly malicious software, attacker 180 may instead stealthily insert vulnerabilities into apparently-beneficial applications.

In some cases, secured enterprise 100 may provide policy directives that restrict the types of applications that can be installed from application repository 160. Thus, application repository 160 may include software that is not negligently developed and is not malware, but that is nevertheless against policy. For example, some enterprises restrict installation of entertainment software like media players and games. Thus, even a secure media player or game may be unsuitable for an enterprise computer. Security administrator 150 may be responsible for distributing a computing policy consistent with such restrictions and enforcing it on client devices 110.

Secured enterprise 100 may also contract with or subscribe to a security services provider 190, which may provide security services, updates, antivirus definitions, patches, products, and services. McAfee®, Inc. is a non-limiting example of such a security services provider that offers comprehensive security and antivirus solutions. In some cases, security services provider 190 may include a threat intelligence capability such as the global threat intelligence (GTI™) database provided by McAfee Inc. Security services provider 190 may update its threat intelligence database by analyzing new candidate malicious objects as they appear on client networks and characterizing them as malicious or benign.

In another example, secured enterprise 100 may simply be a family, with parents assuming the role of security administrator 150. The parents may wish to protect their children from undesirable content, such as pornography, adware, spyware, age-inappropriate content, advocacy for certain political, religious, or social movements, or forums for discussing illegal or dangerous activities, by way of non-limiting example. In this case, the parent may perform some or all of the duties of security administrator 150.

When a new object is first encountered on the network, security policies may initially treat it as “gray” or “suspect.” As a first line of defense, a security appliance in cluster 142 may query security services provider 190 to see if the new object has a globally-recognized reputation. If so, a local reputation may be generated based on that global reputation. If not, the object is completely new and may be treated as a “candidate malicious object,” meaning that its status is unknown, and it may therefore be a malicious object. At a minimum, the new object may be proscribed in its access to protected resources until its reputation can be established. This may mean that extra permission from a user 120 or security administrator 150 is required for the candidate malicious object to access protected resources.

The candidate malicious object may also be subjected to additional rigorous security analysis, particularly if it is a new object with no global reputation, or if it is an executable object. This may include, for example, submitting the object to an internal security audit, or to security services provider 190, for deep analysis. This may include running the object in a sandbox environment, expert status analysis, or other security techniques. These may help to establish a new reputation for the object.

If the object is permitted to operate on the network and malicious behavior is observed, the object may be tagged as malicious object 182. Remedial action may then be taken as appropriate or necessary. Thus, it is a goal of users 120 and security administrator 150 to configure and operate client devices 110, workload cluster 142, and enterprise network 170 so as to exclude all malicious objects, and to promptly and accurately classify candidate malicious objects.

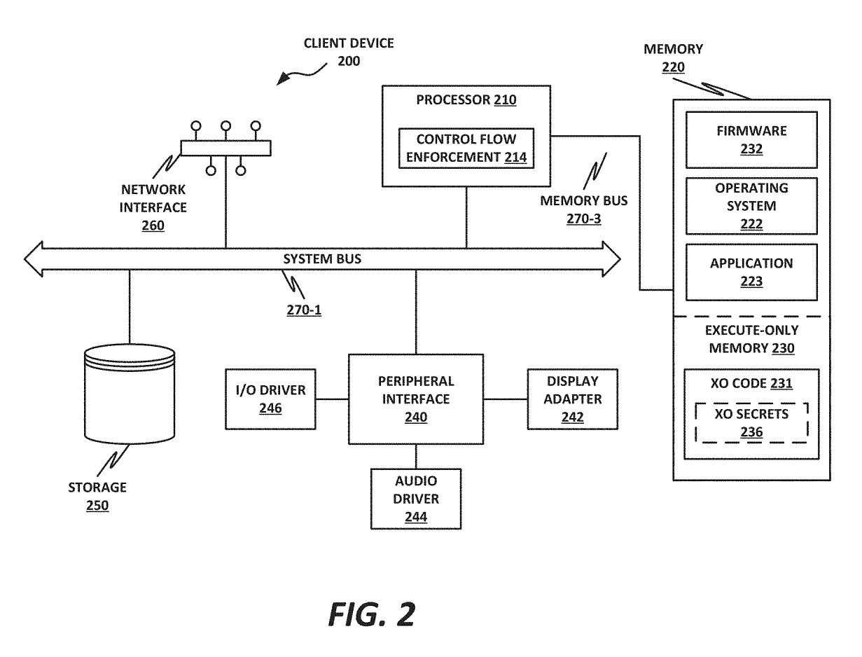

FIG. 2 illustrates an example embodiment of a client device 200 in accordance with the present disclosure. Client device 200 may be any suitable computing device. In various embodiments, a “computing device” may be or comprise, by way of non-limiting example, a computer, workstation, server, mainframe, virtual machine (whether emulated or on a “bare-metal” hypervisor), embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or microelectromechanical device for processing and communicating data. Any computing device may be designated as a host on the network. Each computing device may refer to itself as a “local host,” while any computing device external to it may be designated as a “remote host.”

In certain embodiments, client devices 110 may all be examples of client devices 200.

Client device 200 includes a processor 210 connected to a memory 220, having stored therein executable instructions for providing an operating system 222 and applications 223. Memory 220 also includes a region of execute-only memory 230 used to store execute-only (XO) code 231 and execute-only (XO) secrets 236.

Other components of client device 200 include a storage 250, network interface 260, and peripheral interface 240. This architecture is provided by way of example only, and is intended to be non-exclusive and non-limiting. Furthermore, the various parts disclosed are intended to be logical divisions only, and need not necessarily represent physically separate hardware and/or software components. Certain computing devices provide main memory 220 and storage 250, for example, in a single physical memory device, and in other cases, memory 220 and/or storage 250 are functionally distributed across many physical devices. In the case of virtual machines or hypervisors, all or part of a function may be provided in the form of software or firmware running over a virtualization layer to provide the disclosed logical function. In other examples, a device such as a network interface 260 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, microcode, programmable logic, or objects that can coordinate to achieve a logical operation.

In an example, processor 210 is communicatively coupled to memory 220 via memory bus 270-3, which may be for example a direct memory access (DMA) bus by way of example, though other memory architectures are possible, including ones in which memory 220 communicates with processor 210 via system bus 270-1 or some other bus. Processor 210 may be communicatively coupled to other devices via a system bus 270-1. As used throughout this specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of non-limiting example only, and that some embodiments may omit one or more of the foregoing buses, while others may employ additional or different buses.

In various examples, a “processor” may include any combination of logic elements operable to execute instructions, whether loaded from memory, or implemented directly in hardware, including by way of non-limiting example a microprocessor, digital signal processor, field-programmable gate array, graphics processing unit, programmable logic array, application-specific integrated circuit, or virtual machine processor. In certain architectures, a multi-core processor may be provided, in which case processor 210 may be treated as only one core of a multi-core processor, or may be treated as the entire multi-core processor, as appropriate. In some embodiments, one or more co-processors may also be provided for specialized or support functions.

Processor 210 may be connected to memory 220 in a DMA configuration via DMA bus 270-3. To simplify this disclosure, memory 220 is disclosed as a single logical block, but in a physical embodiment may include one or more blocks of any suitable volatile or non-volatile memory technology or technologies, including for example DDR RAM, SRAM, DRAM, cache, L1 or L2 memory, on-chip memory, registers, flash, ROM, one-time programmable (OTP) memory, optical media, virtual memory regions, magnetic or tape memory, or similar. In certain embodiments, memory 220 may comprise a relatively low-latency volatile main memory, while storage 250 may comprise a relatively higher-latency non-volatile memory. However, memory 220 and storage 250 need not be physically separate devices, and in some examples may represent simply a logical separation of function. It should also be noted that although DMA is disclosed by way of non-limiting example, DMA is not the only protocol consistent with this specification, and that other memory architectures are available.

Storage 250 may be any species of memory 220, or may be a separate device. Storage 250 may include one or more non-transitory computer-readable mediums, including by way of non-limiting example, a hard drive, solid-state drive, external storage, redundant array of independent disks (RAID), network-attached storage, optical storage, tape drive, backup system, cloud storage, or any combination of the foregoing. Storage 250 may be, or may include therein, a database or databases or data stored in other configurations, and may include a stored copy of operational software such as operating system 222 and software portions of trusted execution framework 224. Many other configurations are also possible, and are intended to be encompassed within the broad scope of this specification.

Network interface 260 may be provided to communicatively couple client device 200 to a wired or wireless network. A “network,” as used throughout this specification, may include any communicative platform operable to exchange data or information within or between computing devices, including by way of non-limiting example, an ad-hoc local network, an internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment.

Peripheral interface 240 may be configured to interface with any auxiliary device that connects to client device 200 but that is not necessarily a part of the core architecture of client device 200. A peripheral may be operable to provide extended functionality to client device 200, and may or may not be wholly dependent on client device 200. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage by way of non-limiting example.

In one example, peripherals include display adapter 242, audio driver 244, and input/output (I/O) driver 246. Display adapter 242 may be configured to provide a human-readable visual output, such as a command-line interface (CLI) or graphical desktop such as Microsoft Windows, Apple OSX desktop, or a Unix/Linux X Window System-based desktop. Display adapter 242 may provide output in any suitable format, such as a coaxial output, composite video, component video, VGA, or digital outputs such as DVI or HDMI, by way of non-limiting example. In some examples, display adapter 242 may include a hardware graphics card, which may have its own memory and its own graphics processing unit (GPU). Audio driver 244 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth or Wi-Fi audio, by way of non-limiting example.

Execute-only memory 230 is a region of memory 220 that can only be accessed to retrieve code for execution. Thus, software stored in execute-only memory 230 can be executed by client device 200, but the software code cannot otherwise be read or accessed by client device 200. Software stored in execute-only memory 230 may also contain embedded “secrets,” called execute-only (XO) secrets, which may similarly be protected from access by client device 200. In this manner, sensitive information used by client device 200, such as proprietary software and/or software-embedded secrets, may be protected from access and/or reverse engineering by end users of client device 200. This may allow software developers to protect their confidential intellectual property, prevent piracy, and otherwise shield sensitive information from end users of client device 200.

Execute-only memory 230 can be implemented using any suitable approach for designating one or more regions of execute-only memory 230 and providing execute-only protection to those designated memory regions. In some embodiments, execute-only memory 230 protection may be implemented by system software, such as operating system 222. For example, operating system 222 may use page tables associated with a virtual memory system to designate certain regions of memory 220 as execute-only. System software implementations of execute-only memory 230 protection, however, could allow the execute-only memory 230 protection to be bypassed by the system software and/or its users. For example, the system software and/or its users could remove the execute-only designation from regions of memory 220 containing another developer's proprietary software and/or software-embedded secrets. Thus, in some cases, other developers may not be able to comfortably rely on the execute-only memory 230 protection provided by system software to protect their proprietary software and/or software-embedded secrets. In other embodiments, execute-only memory 230 protection may alternatively, or additionally, be implemented by a component that exists independent of system software such as operating system 222. For example, in some embodiments, execute-only memory 230 protection may be implemented by a component that manages access to memory 220, such as processor 210 or a system agent. In those embodiments, system software may not be able to control or remove execute-only memory 230 protection.

In the illustrated embodiment, execute-only memory 230 includes execute-only (XO) code 231. XO code 231 may include, for example, some or all of the code for certain software, such as firmware 232. In the illustrated embodiment, XO code 231 also includes XO secrets 236. XO secrets 236 may include, for example, confidential keys, encryption keys (e.g., AES encryption keys), device attestation keys, software activation keys, credentials, passwords, and/or any other sensitive information used by XO code 231. Any proprietary software and/or software-embedded secrets can be protected using execute-only memory 230, such as firmware 232, operating system 222, and applications 223.

In some embodiments, XO secrets 236 may be protected using a transactional execution model. For example, execution of XO code 231 from start to finish may be treated as a protected “transaction.” During execution of the protected transaction, any XO secrets 236 loaded into the transaction's execution context by processor 210 may remain there until the transaction either completes or aborts. The protected transaction may be aborted, for example, if the transaction is interrupted before completion. Once the protected transaction either completes or aborts, XO secrets 236 may be cleared from the transaction's execution state, for example, by clearing the XO secrets 236 from any registers of processor 210. Thus, under this transactional model of execution, XO secrets 236 are protected when the transaction starts and until the transaction completes. This protection of XO secrets 236, however, requires the protected transaction to begin and end at the appropriate points of execution in XO code 231. Thus, in some circumstances, attackers could attempt to extract XO secrets 236 by executing only a portion of XO code 231, for example, by entering and/or exiting execution of XO code 231 at an unintended offset in XO code 231.

As described throughout this disclosure, however, control-flow enforcement logic 214 may be used to prevent execution from entering or exiting XO code 231 at an unintended offset. Control-flow enforcement logic 214 may be any suitable combination of hardware and/or software logic operable to restrict code entry and exit, as described throughout this disclosure in connection with the remaining FIGURES.

FIG. 3 illustrates an example embodiment of a server 300 in accordance with the present disclosure. Server 300 may be any suitable computing device, including, for example, client device 200 of FIG. 2. In general, the definitions and examples of FIG. 2 may be considered as equally applicable to FIG. 3, unless specifically stated otherwise. Server 300 is described herein separately to illustrate that in certain embodiments, logical operations according to this specification may be divided along a client-server model, wherein the client device (e.g., client device 200 of FIG. 2) provides certain localized tasks, while server 300 provides certain other centralized tasks. In contemporary practice, server 300 is more likely to be provided as a “headless” VM running on a computing cluster, or as a standalone appliance, though these configurations are not required.

Server 300 includes a processor 310 connected to a memory 320, having stored therein executable instructions for providing an operating system 322 and at least software portions of a server engine 324. Other components of server 300 include a storage 350, network interface 360, and peripheral interface 340. As described in FIG. 2, each logical block may be provided by one or more similar or dissimilar logic elements.

In an example, processor 310 is communicatively coupled to memory 320 via memory bus 370-3, which may be for example a direct memory access (DMA) bus. Processor 310 may be communicatively coupled to other devices via a system bus 370-1. Processor 310 may be connected to memory 320 in a DMA configuration via DMA bus 370-3, or via any other suitable memory configuration. As discussed in FIG. 2, memory 320 may include one or more logic elements of any suitable type.

Storage 350 may be any species of memory 320, or may be a separate device, as described in connection with storage 250 of FIG. 2. Storage 350 may be, or may include therein, a database or databases or data stored in other configurations, and may include a stored copy of operational software such as operating system 322 and software portions of server engine 324.

Network interface 360 may be provided to communicatively couple server 300 to a wired or wireless network, and may include one or more logic elements as described in FIG. 2.

Server engine 324 may be any combination of logic and/or software elements executing on server 300 to provide a particular service. In some embodiments, software portions of server engine 324 may run as a daemon process. Server engine 324 may include one or more non-transitory computer-readable mediums having stored thereon executable instructions operable to instruct a processor to provide server engine 324. At an appropriate time, such as upon booting server 300 or upon a command from operating system 322 or a user 120 or security administrator 150, processor 310 may retrieve a copy of server engine 324 (or software portions thereof) from storage 350 and load it into memory 320. Processor 310 may then iteratively execute the instructions of server engine 324 to provide the desired server functionality.

Peripheral interface 340 may be configured to interface with any auxiliary device that connects to server 300 but that is not necessarily a part of the core architecture of server 300. Peripherals may include, by way of non-limiting examples, any of the peripherals disclosed in FIG. 2. In some cases, server 300 may include fewer peripherals than client device 200 of FIG. 2, reflecting that it may be more focused on providing processing services rather than interfacing directly with users.

Execute-only memory 330 is a region of memory 320 that, in conjunction with control-flow enforcement logic 314, may be used to protect sensitive information used by server 300, such as proprietary software and/or software-embedded secrets, from access and/or reverse engineering by end users of server 300, as described throughout this disclosure in connection with the remaining FIGURES. For example, in the illustrated embodiment, execute-only memory 330, in conjunction with control-flow enforcement logic 314, may be used to protect execute-only (XO) code 331 and its embedded execute-only (XO) secrets 336. This may allow software developers to protect their confidential intellectual property, prevent piracy, and otherwise shield sensitive information from end users of server 300.

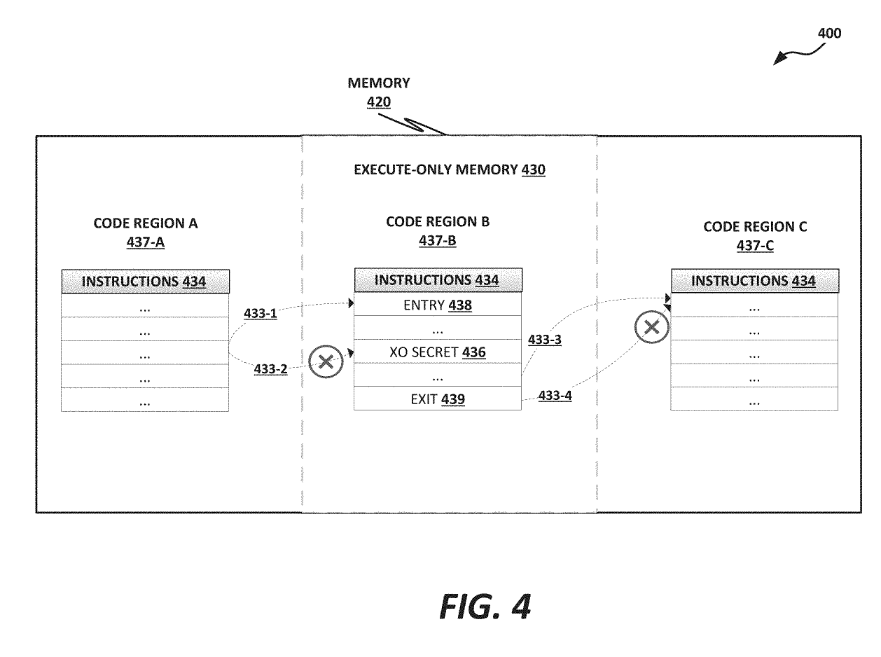

FIG. 4 illustrates examples of control-flow enforcement in an execute-only memory environment 400.

In the example of FIG. 4, memory 420 of execute-only memory environment 400 includes a region of execute-only memory 430. Execute-only memory 430 is a region of memory 420 used to store code, called execute-only (XO) code, that can only be accessed for purposes of code execution. Thus, software stored in execute-only memory 430 can be executed by a client device, but the software code cannot otherwise be read or accessed by the client device. Software stored in execute-only memory 430 may also contain embedded “secrets,” called execute-only (XO) secrets, which may similarly be protected from access by a client device. In this manner, sensitive information used by a client device, such as proprietary software and/or software-embedded secrets, may be protected from access and/or reverse engineering by end users of the client device. This may allow software developers to protect their confidential intellectual property, prevent piracy, and otherwise shield sensitive information from end users of a client device. For example, in the illustrated embodiment, execute-only memory 430 contains code region B (437-B), and code region B (437-B) includes XO secret 436. Thus, in the illustrated embodiment, code region B (437-B) and XO secret 436 would be protected from access by the client device for any purpose other than code execution.

Execute-only memory 430 can be implemented using any suitable approach for providing execute-only protection to regions of memory 420 that are designated as execute-only memory 430. In some embodiments, execute-only memory 430 protection may be implemented by system software, such as an operating system. For example, the operating system may use page tables associated with a virtual memory system to designate certain regions of memory 420 as execute-only memory 430. System software implementations of execute-only memory 430 protection, however, could allow the execute-only memory 430 protection to be bypassed by the system software and/or its users. For example, the system software and/or its users could remove the execute-only designation from regions of memory 420 containing another developer's proprietary software and/or software-embedded secrets. Thus, in some cases, other developers may not be able to comfortably rely on the execute-only memory 430 protection provided by system software to protect their proprietary software and/or software-embedded secrets. Accordingly, in other embodiments, execute-only memory 430 protection may alternatively, or additionally, be implemented by a component that exists independent of the operating system or other system software. In those embodiments, the system software may not be able to control or remove execute-only memory 430 protection. For example, in some embodiments, execute-only memory 430 protection may be implemented by a component that manages access to memory 420, such as a processor or a system agent. In those embodiments, designations of execute-only memory 430 may be specified using a memory range register, such as a memory type range register (MTRR) or a persistent memory range register (PMRR).

In some embodiments, execute-only (XO) secrets, such as XO secret 436, may be protected using a transactional execution model. For example, execution from start to finish of the XO code containing the XO secret may be treated as a protected “transaction.” In the illustrated embodiment, execution of code region B (437-B) from entry 438 through exit 439 may be treated as a protected transaction. During execution of the protected transaction, the XO secret should only be accessible to the XO code. Thus, any XO secrets loaded into the protected transaction's execution state may remain there until the transaction either completes or aborts. The protected transaction may be aborted, for example, if the transaction is interrupted before completion. Once the protected transaction either completes or aborts, the XO secrets may be cleared from the transaction's execution state, for example, by clearing the XO secrets from any processor registers. Thus, under this transactional model of execution, XO secrets are protected when the transaction starts and until the transaction completes. Protection of XO secrets in this manner, however, requires the protected transaction to begin and end at the appropriate points of execution in the XO code. Thus, in some circumstances, attackers could attempt to extract the XO secrets by executing only a portion of the XO code, for example, by entering and/or exiting execution of the XO code at an unintended offset in the XO code.

As described throughout this disclosure, control-flow enforcement may be used to provide further protection of XO secrets, for example, by preventing execution from entering and/or exiting XO code at an unintended offset. In some embodiments, invalid entry and/or exit of XO code execution may result in a fault, exception, abort, virtual machine exit, and/or similar error.

Control-flow enforcement may be implemented by any suitable combination of hardware and/or software logic operable to restrict code entry and/or exit. For example, in one embodiment, control-flow enforcement may be implemented by Intel® Control-Flow Enforcement Technology (CET) or similar. In some embodiments, control-flow enforcement may be implemented by a processor. In addition, control-flow enforcement may be implemented using any suitable approach for restricting entry and/or exit of XO code execution, including via processor instructions, defined code segment offsets, protection keys, and/or privilege levels.

Control-flow enforcement may be implemented, in some embodiments, by restricting valid entry and exit points for XO code using processor instructions. In those embodiments, entry and exit processor instructions may be defined that identify valid entry and/or exit points of XO code based on the location of the processor instruction in the XO code. Thus, any control-flow transfer into the XO code must land on an entry instruction, and any control-flow transfer out of XO code must occur after an exit instruction. Otherwise, the control-flow transfer may generate a fault or similar error. For example, the XO code may be constructed to include entry instructions at desired entry points, and exit instructions at desired exit points. A control-flow transfer into the XO code (e.g., via an indirect branch, such as a jump or call instruction) must land on an entry instruction in the XO code, and a control-flow transfer out of the XO code (e.g., via an interrupt, or a jump or call instruction) must occur after an exit instruction in the XO code.

In some embodiments, for example, an ENDBRANCH instruction may be used to identify valid entry points into the XO code. Alternatively, or additionally, a BEGIN XOS ENDBRANCH instruction may be used in conjunction with an XEND instruction to identify the valid entry and exit points of the XO code. For example, the BEGIN XOS ENDBRANCH instruction may be used to identify valid entry points into the XO code, and the XEND instruction may be used to identify valid exit points from the XO code. In this manner, the BEGIN XOS ENDBRANCH and XEND instructions may be used to define the start and end of a protected transaction.

In some embodiments, a control-flow transfer that exits the XO code can trigger an abort of the protected XO code transaction. For example, a control-flow transfer from XO code to another code region, which occurs after a BEGIN XOS ENDBRANCH instruction but before the corresponding XEND instruction in the XO code, may result in an abort of the protected transaction. In some embodiments, aborting the protected transaction may result in clearing the transaction execution state, for example, by clearing any XO secrets from the processor registers. In some embodiments, control-flow transfers that exit the XO code may be identified by determining whether the destination memory address of the control-flow transfer is within the protected XO code transaction. This determination may be performed, for example, at instruction fetch time or branch retire.

Control-flow enforcement may alternatively or additionally be implemented, in some embodiments, by restricting valid entry and exit points for XO code to acceptable offsets within a particular code segment.

For example, some embodiments may require execution of an XO code segment (e.g., code region B (437-B)) to begin or end at a set of acceptable offsets within the code segment. In some embodiments, these entry and exit points may be non-configurable. Alternatively, in other embodiments, these entry and exit points may be configurable. For example, the entry and exit points may be globally configurable by specifying an acceptable entry or exit point offset in a global configuration register. In other embodiments, the entry and exit points may be configured separately for each code segment, for example, by specifying the entry or exit point offsets as fields in a global descriptor table and/or code segment descriptor.

Finally, in these offset-based embodiments, the entry points could be enforced by determining if the destination address of a control-flow transfer is at a valid entry point offset within an XO code segment. Alternatively, a control-flow transfer into an XO code segment may simply be executed using a valid entry point offset as the destination address even if another invalid entry point was specified as the destination address.

Control-flow enforcement may alternatively or additionally be implemented, in some embodiments, by restricting valid entry and exit points for XO code using protection keys.

Protection keys may be used, for example, to ensure that software processes have the appropriate permissions to access memory assigned with a particular protection key. For example, protection keys allow different regions of memory to be assigned different levels of protection, forming “protection domains” that each correspond to the memory regions with a particular protection key. In this manner, protection keys may be used in some embodiments to designate certain regions of memory 420 as execute-only memory 430.

When protection keys are used to designate execute-only memory 430, control-flow enforcement can be implemented for control-flow transfers that switch between protection key domains. Control-flow enforcement using protection keys can be implemented as an alternative to, or an addition to, control-flow enforcement using code segment offsets as described above. In some embodiments, control-flow transfers between protection key domains can be detected by examining the protection key for the page mapping of each code fetch. Detecting transitions between protection key domains, however, may require addressing an additional scenario that does not occur when transitioning between code segments. For example, control-flow transfers between code segments always involve control-flow transfer instructions, such as branch instructions (e.g., call or jump instructions), interrupts, and exceptions. Control-flow can transition between different protection key domains, however, without a control-flow instruction, simply by crossing a protection key page boundary. For example, even a single instruction may span a protection key page boundary. When control-flow enforcement is enabled, an instruction that enters an XO code region by spanning a protection key page boundary should be disallowed and generate a fault, unless offset 0 of the new protection key page is marked as an acceptable entry point.

Control-flow enforcement may alternatively or additionally be implemented, in some embodiments, by restricting valid entry and exit points for XO code using privilege levels.

For example, in some embodiments, software processes may execute at various privilege levels, such as ring 0, 1, or 2 in a protection ring architecture. In these embodiments, XO code segments with controlled entry points may be marked with a Descriptor Privilege Level that is numerically lower than the Current Privilege Level of the code that will invoke those XO code segments. For example, for an application that executes in ring 3, the controlled XO code segments could be placed in ring 2. In addition, the controlled XO code segments in ring 2 could be marked as “conforming,” which would allow the controlled XO code segments to execute in ring 3 (i.e., with a Current Privilege Level of 3). Absent any control-flow enforcement mechanism, it would be possible for any ring 3 code to jump to any offset within a “conforming” ring 2 code segment. Control-flow enforcement may be implemented, however, by defining a new mode that, when enabled, blocks control-flow transfers to XO code segments with a Descriptor Privilege Level that is more privileged than the Current Privilege Level. In this manner, any control-flow transfers to the “conforming” XO code segment would need to be performed through a call gate, which imposes its own entry point control.

Alternatively, in some embodiments, all control-flow transfers between code segments could be blocked, even if the code segments are within the same privilege level. In this manner, any control-flow transfers to an XO code segment would need to be performed through a call gate, which imposes its own entry point control.

Control-flow enforcement may, in some embodiments, be enabled or disabled using a defined processor mode. The processor mode for control-flow enforcement could be enabled or disabled, for example, by setting or clearing a corresponding bit in a configuration or control register, such as a model-specific register (MSR). In addition, in some embodiments, a secondary configuration level may be used to enable or disable control-flow enforcement for particular code regions. For example, in some embodiments, control-flow enforcement may be enabled or disabled for particular code segments by setting or clearing a corresponding bit in a global descriptor table and/or code segment descriptor. Alternatively, control-flow enforcement may be enabled or disabled for particular protection key domains by setting or clearing a corresponding bit for a particular protection key domain. Finally, control-flow enforcement may be enabled for code regions that are designated as execute-only (XO) by a memory range register, such as a memory type range register (MTRR) or a persistent memory range register (PMRR). In this manner, control-flow enforcement may only be enforced for a particular code region if the global configuration, and the secondary configuration for the particular code region, are both enabled.

In the example control-flow enforcement of FIG. 4, memory 420 includes code region A (437-A), code region B (437-B), and code region C (437-C). Each code region 437 includes processor instructions 434. Memory 420 also includes a region of execute-only memory 430, which is used to store code region B (437-B). Code region B (437-B) may include, for example, some or all of the code for certain software. In the illustrated embodiment, execute-only (XO) secret 436 is embedded in the instructions 434 of code region B (437-B). For example, in some embodiments, XO secrets 436 may be embedded as constant values in instructions 434. In this manner, XO secrets 436 may be embedded in the code that utilizes them rather than in data stored separately from the code. XO secret 436 may include, for example, confidential keys, encryption keys (e.g., AES encryption keys), device attestation keys, software activation keys, credentials, passwords, and/or any other sensitive information used by code region B (437-B). Although the illustrated embodiment uses execute-only memory 430 to protect code region B (437-B) and its embedded XO secret 436, in general execute-only memory 430 may be used to protect any proprietary software and/or software-embedded secrets, including firmware, operating systems, applications, and any secrets embedded therein.

The illustrated embodiment depicts attempted control-flow transfers 433 among code regions A, B, and C. In the illustrated embodiment, control-flow enforcement is provided for code region B, which is stored in execute-only memory 430. Code region B, for example, is marked with an entry 438 and an exit 439. Entry 438 and exit 439 may identified using any of the control-flow enforcement implementations described above, including via processor instructions, defined code segment offsets, protection keys, and/or privilege levels.

In the illustrated embodiment, execution begins with the first instruction 434 of code region A. No control-flow enforcement is applied when executing code in code region A, however, since code region A is not stored in execute-only memory 430. Thus, execution could begin at any instruction 434 in code region A.

If code region A attempts a control transfer to code region B, for example, via a jump or call instruction, control-flow enforcement is applied since code region B is within execute-only memory 430. If the control transfer attempts to enter code region B at entry 438, as depicted by control transfer 433-1, then the control transfer will be allowed. However, if the control transfer attempts to enter code region B somewhere other than entry 438, as depicted by control transfer 433-2, then the control transfer will be blocked, and in some embodiments, a fault may be generated.

Assuming code region B is properly entered at entry 438, then code region B will be executed. If code region B then attempts a control transfer to code region C, for example, via a jump or call instruction, control-flow enforcement is applied since code region B is within execute-only memory 430. If the control transfer attempts to leave code region B before exit 439 of code region B has been reached, as depicted by control transfer 433-3, then the control transfer will be blocked. In some embodiments, execution of protected code region B may then be aborted, a fault may generated, and/or XO secret 436 may be cleared from the execution state (e.g., by clearing the processor registers). If the control transfer attempts to leave code region B when exit 439 of code region B has been reached, as depicted by control transfer 433-4, then the control transfer will be allowed, and code region C will be executed.

Protecting secrets using control-flow enforcement in conjunction with execute-only (XO) memory, as described throughout this disclosure, provides transactional security in a light-weight manner. Alternative embodiments that may seek to protect secrets without using control-flow enforcement (e.g., by avoiding context switches to achieve restricted access to the secrets) require inefficient mechanisms to compensate for the lack of control-flow enforcement (e.g., the lack of entry point control and/or exit control). Another alternative embodiment of protecting secrets without using control-flow enforcement requires structuring the execute-only (XO) code and embedded secrets such that no information about the secret is revealed regardless of where an adversary may enter into execution of the execute-only (XO) code. For example, in that alternative embodiment, secrets may be encoded such that the resultant immediate values are ignored prefixes for no operation (NOP) instructions that follow the prefixes. This encoding scheme may have a very small data density, however, such as 3 secret bits for each encoded byte, which greatly increases the number of instructions needed to load and decode the secret, reduces performance, and also increases code size.

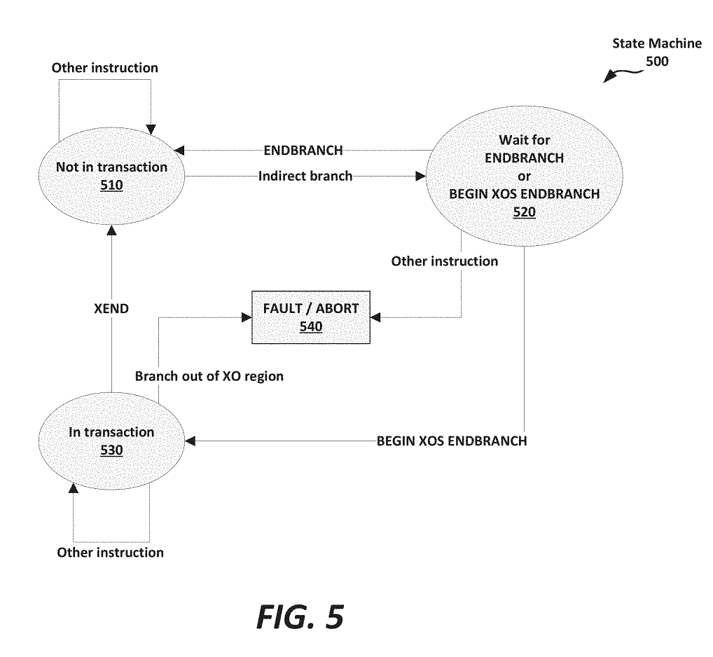

FIG. 5 illustrates a state machine 500 in an example embodiment of control-flow enforcement for execute-only code execution.

State machine 500 implements an embodiment of control-flow enforcement using the ENDBRANCH, BEGIN XOS ENDBRANCH, and XEND instructions described in connection with FIG. 4. The state machine begins in state 510, where the machine is not in a protected transaction. The machine remains in state 510 and continues executing instructions until an indirect branch instruction is detected. An indirect branch instruction could be, for example, a call or jump instruction. When an indirect branch is detected, the state machine transitions to state 520, where the machine waits for an ENDBRANCH or BEGIN XOS ENDBRANCH instruction.

In state 520, if the next instruction is neither an ENDBRANCH nor BEGIN XOS ENDBRANCH instruction, the state machine transitions to state 540 and generates a fault, because the indirect branch attempted to enter code at an invalid entry point. In state 520, if the next instruction is an ENDBRANCH instruction, the machine transitions back to state 510, where the machine is not in a protected transaction and continues executing instructions, as described above. In state 520, if the next instruction is a BEGIN XOS ENDBRANCH instruction, the machine transitions to state 530, where the machine enters a protected transaction in execute-only (XO) memory and continues executing instructions.

In state 530, the machine continues executing instructions in a protected transaction until an XEND instruction is detected, or until a branch out of the execute-only (XO) region is detected. If an XEND instruction is detected in state 530, the protected transaction exits and the machine transitions to state 510, where the machine is no longer in a protected transaction and continues executing instructions, as described above. If a branch out of the execute-only (XO) region is detected in state 530, the state machine transitions to state 540 and generates a fault, because branches out of a protected transaction before the transaction ends are prohibited.

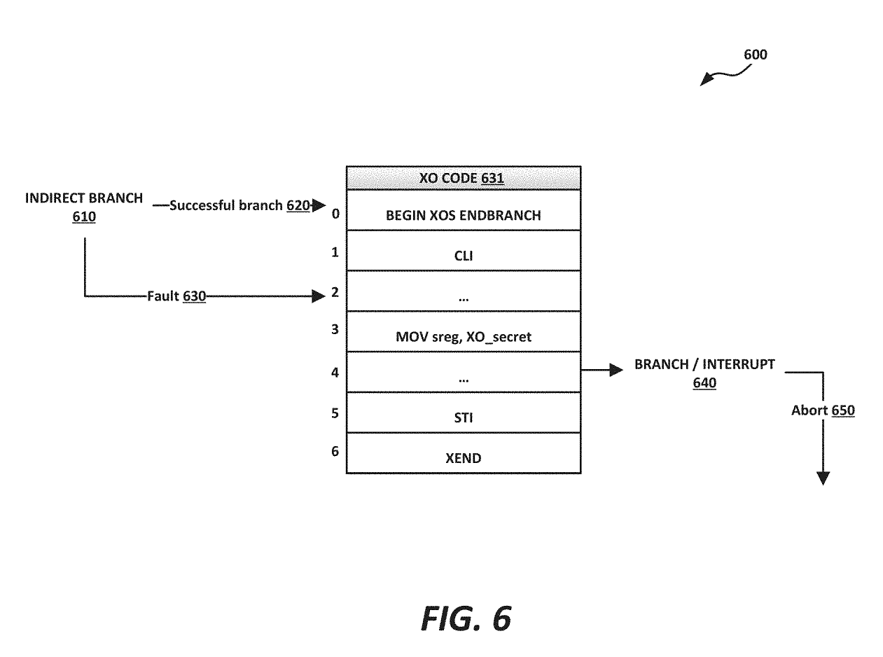

FIG. 6 illustrates an example embodiment 600 of using processor instructions for control-flow enforcement for execute-only code execution. In the illustrated embodiment 600, control-flow enforcement is implemented using the BEGIN XOS ENDBRANCH and XEND instructions described in connection with FIG. 4.

The illustrated embodiment 600 includes a region of execute-only (XO) code 631, which is code stored in execute-only memory, as described throughout this disclosure. XO code 631 contains instructions 0-6. The BEGIN XOS ENDBRANCH instruction (instruction 0) identifies the appropriate entry point into XO code 631 and causes the subsequent instructions to be treated as a protection transaction. The CLI instruction (instruction 1) clears the interrupt flag to disable interrupts. The MOV instruction (instruction 3) moves an execute-only (XO) secret into sreg, a system register. The STI instruction (instruction 5) sets the interrupt flag to enable interrupts. Finally, the XEND instruction (instruction 6) identifies the appropriate exit out of XO code 631 and ends the protection transaction.

XO code 631 is first entered via an indirect branch, such as a call or jump instruction, as depicted by reference numeral 610. If the indirect branch enters XO code 631 at instruction 0, which is the BEGIN XOS ENDBRANCH instruction, then the branch is successful, as depicted by reference numeral 620. If the indirect branch enters XO code 631 at any instruction other than the BEGIN XOS ENDBRANCH instruction, then the branch is unsuccessful and a fault is generated, as depicted by reference numeral 630.

Assuming the branch into XO code 631 was successful (i.e., XO code 631 was entered at the BEGIN XOS ENDBRANCH instruction), a protected transaction begins and the instructions in XO code 631 are executed iteratively. During execution of XO code 631, there may be an attempted branch or interrupt out of XO code 631 before the XEND instruction is executed, as depicted by reference numeral 640. Although interrupts were disabled by the CLI instruction (instruction 1) in the illustrated example, in other examples interrupts may not necessarily be disabled. If there is a branch or interrupt out of XO code 631 before the XEND instruction is executed, the protected transaction may be aborted, as depicted by reference numeral 650. If execution is not aborted by an improper branch or interrupt attempt, XO code 631 will continue executing. The protected transaction ends once the XEND instruction (instruction 6) is executed, and any subsequent control-flow transfers outside of XO code 631 will be allowed.

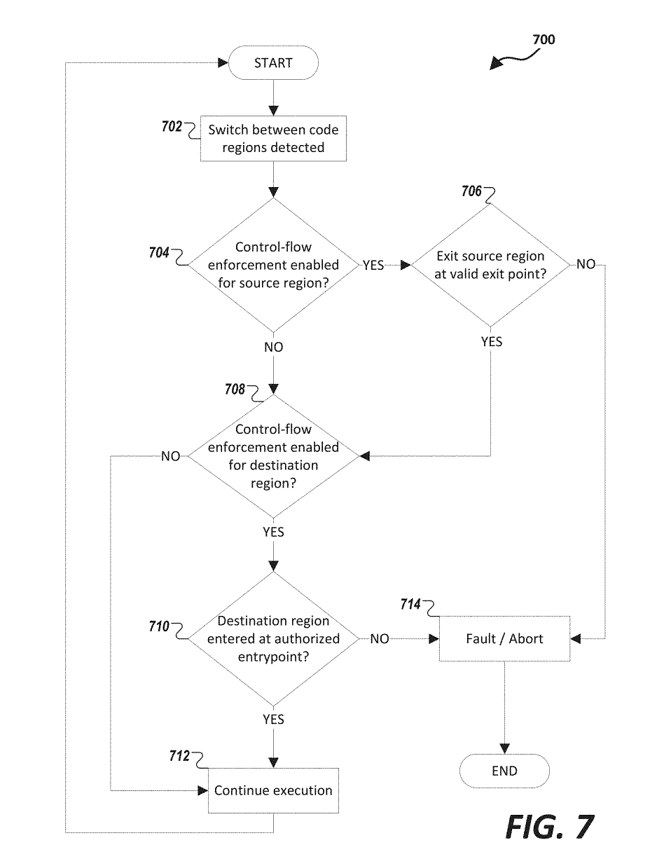

FIG. 7 illustrates an example embodiment of a method 700 of control-flow enforcement for execute-only code execution.

In particular embodiments, control-flow enforcement may be used to protect sensitive information stored in execute-only (XO) memory of a computing device, such as proprietary software and/or software-embedded secrets, from access and/or reverse engineering by end users or attackers, as described throughout this disclosure. Method 700 may be implemented, for example, by computing entities of FIG. 1, client device 200 of FIG. 2, and/or server 300 of FIG. 3.

The method may start at block 702, where a switch between code regions is detected during code execution, for example, via a control-flow transfer such as an indirect branch or interrupt. The method may then proceed to block 704, where it is determined if control-flow enforcement is enabled for the source region where the control-flow transfer originated. Control-flow enforcement may be enabled or disabled, for example, as described in connection with FIG. 4. If it is determined at block 704 that control-flow enforcement is enabled for the source region, then at block 706 it is determined if the source region exited at a valid exit point. For example, in embodiments that use the BEGIN XOS ENDBRANCH and XEND instructions described in FIGS. 4-6, the source region exited at a valid exit point if the XEND instruction had been executed in the source region. If it is determined at block 706 that the source region did not exit at a valid exit point, then the method proceeds to block 714, where a fault is generated and/or execution is aborted. In some embodiments, any secrets used by the source region may then be cleared from the execution state, for example by clearing the processor registers. At this point, the method may be complete.

If it is determined at block 704 that control-flow enforcement is not enabled for the source region, or if it is determined at block 706 that the source region did exit at a valid exit point, then the method proceeds to block 708, where it is determined if control-flow enforcement is enabled for the destination region of the control-flow transfer. Control-flow enforcement may be enabled or disabled, for example, as described in connection with FIG. 4.

If it is determined at block 708 that control-flow enforcement is enabled for the destination region of the control-flow transfer, then the method proceeds to block 710, where it is determined if the destination region is entered at an authorized entry point. For example, in embodiments that use the BEGIN XOS ENDBRANCH and XEND instructions described in FIGS. 4-6, the destination region is entered at an authorized entry point if it is entered at a BEGIN XOS ENDBRANCH instruction.

If it is determined at block 710 that the destination region is not entered at an authorized entry point, then the method proceeds to block 714, where a fault is generated and/or execution is aborted. At this point, the method may be complete.

If it is determined at block 708 that control-flow enforcement is not enabled for the destination region, or if it is determined at block 710 that the destination region is entered at an authorized entry point, then the method proceeds to block 712, where execution continues normally. At this point, the method may be complete, although in particular embodiments, the method may restart at block 702 when the next switch between code regions is detected.

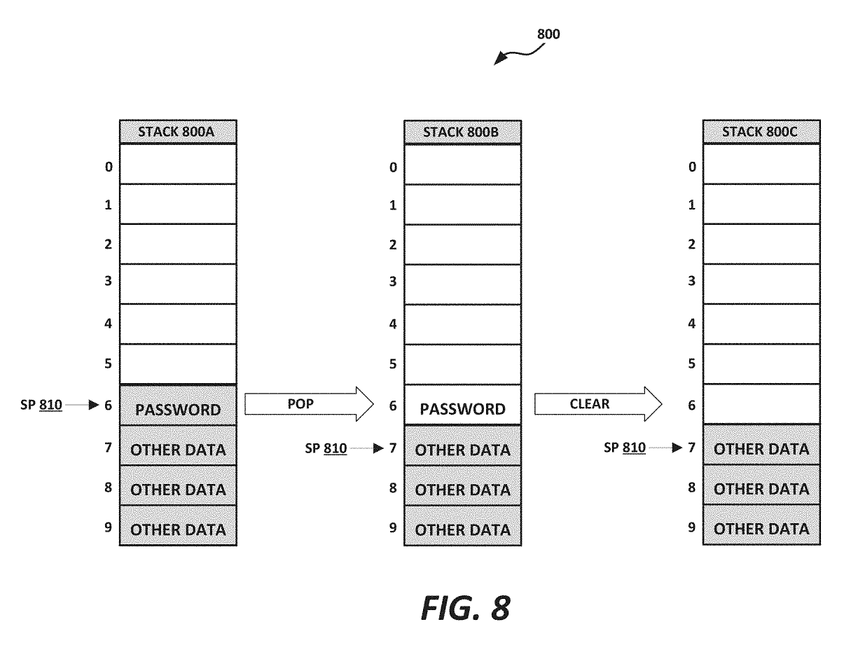

FIG. 8 illustrates an example of automatically clearing stack 800 data after a stack pop operation.

In some computing environments, mutually-distrustful pieces of software may share stack space, for example, if they are executing on a device with limited resources and dedicating a separate stack to each piece of software is infeasible (e.g., on an Internet-of-Things device and/or mobile device with a small amount of memory). In these computing environments, one piece of software may inadvertently leave secrets in the shared stack space, and those secrets may subsequently be leaked to the other piece of software. Secrets may be leaked, for example, if instructions that perform stack pop operations, such as POP instructions, do not automatically overwrite the stack slot that is popped.

Accordingly, in some embodiments, instructions that perform stack pop operations may be implemented such that they automatically overwrite and/or clear the stack slot that is popped. This stack overwrite functionality may be implemented, for example, for a POP instruction or equivalent instruction, and/or any other instructions that remove data from the stack, such as RET and IRET instructions.

A variety of mechanisms may be used to indicate which instructions trigger this stack overwrite functionality, such as, for example, an instruction prefix, a bit in an EFLAGS register, RFLAGS register, or similar register, a distinct instruction opcode, a flag in the stack segment descriptor or code segment descriptor, a distinct stack or code segment descriptor type, and/or a flag in a model-specific register (MSR), protection key register (PKR), or other configuration register. Alternatively, or additionally, the stack overwrite functionality may be triggered for stack pop operations performed on stack slots within a specified stack memory range, and/or for stack pop operations performed by instructions within a specified code memory range. For example, in embodiments with execute-only (XO) memory protection, the stack overwrite functionality may be triggered for stack pop operations performed by instructions stored in execute-only (XO) memory.

This stack overwrite functionality may be, in some embodiments, optional functionality that may be enabled or disabled. Any suitable mechanism for enabling or disabling the stack overwrite functionality may be used, such as an instruction prefix, a flag, a memory range, a stack segment descriptor type setting, and/or a configuration register setting. In some embodiments, for example, stack overwrite functionality may be enabled to provide further protection of execute-only (XO) secrets that are stored on the stack.

In the illustrated embodiment, stack 800 is depicted in three different states shown as stack 800A, stack 800B, and stack 800C. Stack 800A depicts an example of the stack contents before a stack pop operation is performed. Stack 800A includes four entries at stack slots 6-9. Stack pointer (SP) 810, which is used to identify the top of the stack, identifies stack slot 6 as the top of the stack. In the illustrated embodiment, stack slot 6 of stack 800A contains a password, while stack slots 7-9 contain other miscellaneous data. If a stack pop operation is performed, the password stored in slot 6 will be popped from the stack since it resides at the top of the stack.

Stack 800B depicts an example of the stack contents after a stack pop operation is performed on stack 800A. Stack 800B includes three entries at stack slots 7-9, and stack pointer (SP) 810 identifies stack slot 7 as the top of the stack. Stack slot 6 in stack 800B is not within the current boundaries of stack 800B since it is beyond the stack pointer (SP) 810, which identifies stack slot 7 as the top of the stack. Stack slot 6 of stack 800B, however, still contains the password that was popped from stack 800A, and thus the password could still be read from stack slot 6 unless it is overwritten.

In embodiments with stack overwrite functionality, the stack pop operation additionally clears the popped stack slot, as depicted in stack 800C. In stack 800C, the password has been wiped from stack slot 6, and thus it cannot be inadvertently leaked or accessed.

An alternative embodiment may require replacing each instruction that performs a stack pop operation with equivalent instructions that additionally overwrite the stack slot that is popped. For example, a POP instruction may be replaced with a sequence of instructions, such as MOV instructions to read and then clear the popped stack data slot, and an ADD ESP instruction to update the stack pointer. This alternative embodiment, however, may consume additional code space and may execute slower than the embodiments described above (e.g., where the stack overwrite functionality is implemented directly in instructions that perform stack pop operations). In addition, this alternative embodiment may require complicated compiler modifications that may not be necessary in the embodiments described above.

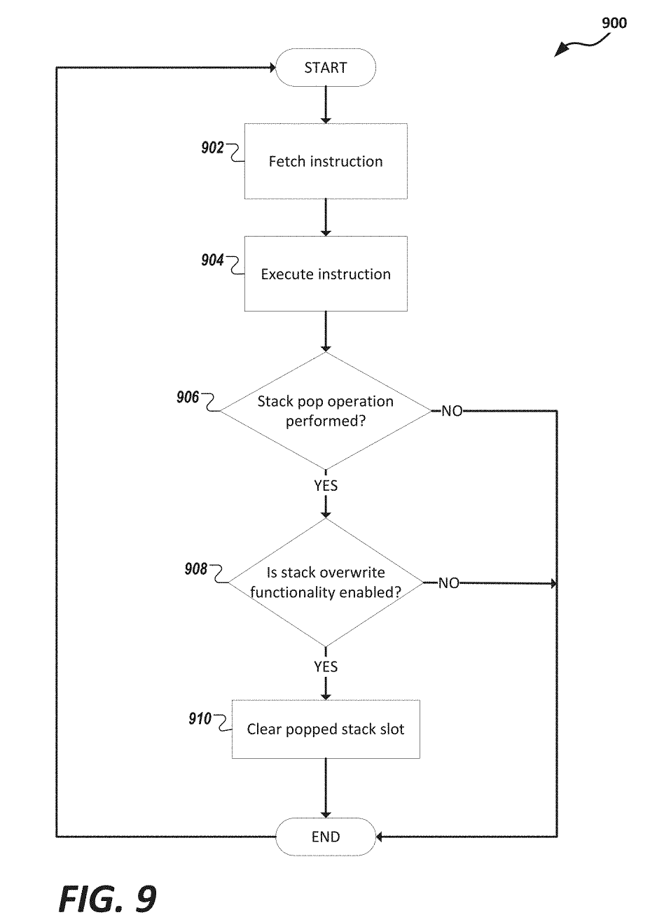

FIG. 9 illustrates an example embodiment of a method 900 for automatically clearing stack data after a stack pop operation.

In particular embodiments, instructions that perform stack pop operations may be implemented such that they automatically overwrite and/or clear the stack slot that is popped, for example, to avoid leaking secrets stored on the stack, as described throughout this disclosure and in connection with FIG. 8. Method 900 may be implemented, for example, by computing entities of FIG. 1, client device 200 of FIG. 2, and/or server 300 of FIG. 3.

The method may start at block 902, where an instruction is fetched from memory. The method may then proceed to block 904, where the instruction is executed. The method may then proceed to block 906, where it is determined if the instruction performed a stack pop operation. Instructions that perform stack pop operations (and that should implement stack overwrite functionality) may be identified using any suitable mechanism, such as those described in connection with FIG. 8.

If it is determined at block 906 that the instruction performed a stack pop operation, then the method may proceed to block 908, where it is determined if the stack overwrite functionality is enabled. Stack overwrite functionality may be enabled or disabled, for example, using any suitable mechanism, such as those described in connection with FIG. 8. If it is determined at block 908 that the stack overwrite functionality is enabled, then the method may proceed to block 910, where the memory location corresponding to the popped stack slot is cleared and/or overwritten.

If it is determined at block 906 that the instruction did not perform a stack pop operation, or if it is determined at block 908 that the stack overwrite functionality is disabled, then no stack overwrite functionality is performed, and the method may be complete for the current instruction. In particular embodiments, the method may restart at block 902, where the next instruction is fetched from memory and is processed as described above with respect to blocks 902-910.

The foregoing outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in a system-on-a-chip (SoC), including central processing unit (CPU) package. An SoC represents an integrated circuit (IC) that integrates components of a computer or other electronic system into a single chip. Thus, for example, client devices 110 or server devices 300 may be provided, in whole or in part, in an SoC. The SoC may contain digital, analog, mixed-signal, and radio frequency functions, all of which may be provided on a single chip substrate. Other embodiments may include a multi-chip-module (MCM), with a plurality of chips located within a single electronic package and configured to interact closely with each other through the electronic package. In various other embodiments, the computing functionalities disclosed herein may be implemented in one or more silicon cores in Application Specific Integrated Circuits (ASICs), Field Programmable Gate Arrays (FPGAs), and other semiconductor chips.

Note also that in certain embodiment, some of the components may be omitted or consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, a storage (e.g., storage 250 of FIG. 2) may store information in any suitable type of tangible, non-transitory storage medium (for example, random access memory (RAM), read only memory (ROM), field programmable gate array (FPGA), erasable programmable read only memory (EPROM), electrically erasable programmable ROM (EEPROM), etc.), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein (e.g., memory 220 and storage 250 of FIG. 2) should be construed as being encompassed within the broad terms ‘memory’ and ‘storage,’ as appropriate. A non-transitory storage medium herein is expressly intended to include any non-transitory special-purpose or programmable hardware configured to provide the disclosed operations, or to cause a processor to perform the disclosed operations.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise expressly reflected in the appended claims.

The following examples pertain to embodiments disclosed in accordance with this specification.

One or more embodiments may provide a machine accessible storage medium having instructions stored thereon that, when executed on a machine, cause the machine to: detect a first control transfer operation; determine that a destination of the first control transfer operation is within code stored in execute-only memory; generate a fault if the destination of the first control transfer operation is an invalid entry point into the code stored in execute-only memory; detect a second control transfer operation while executing the code stored in execute-only memory; and abort execution of the code stored in execute-only memory if the second control transfer operation is detected at an invalid exit point in the code.

In one example, one or more secrets are embedded in the code stored in execute-only memory as constant values in one or more processor instructions.

In one example, the instructions that cause the machine to abort execution of the code stored in execute-only memory if the second control transfer operation is detected at an invalid exit point in the code further cause the machine to clear the one or more secrets from one or more registers.

In one example, a valid entry point into the code is identified based on a location of a particular processor instruction in the code.

In one example, a valid exit point of the code is identified based on a location of a particular processor instruction in the code.

In one example, a valid entry point into the code is identified as an offset into a code segment containing the code.

In one example, the instructions further cause the machine to: detect a stack pop operation during execution of the code stored in execute-only memory; and clear contents of a memory location retrieved from the stack by the stack pop operation.

One or more embodiments may provide an apparatus comprising a processor configured to: detect a first control transfer operation; determine that a destination of the first control transfer operation is within code stored in execute-only memory; generate a fault if the destination of the first control transfer operation is an invalid entry point into the code stored in execute-only memory; detect a second control transfer operation while executing the code stored in execute-only memory; and abort execution of the code stored in execute-only memory if the second control transfer operation is detected at an invalid exit point in the code.

In one example, one or more secrets are embedded in the code stored in execute-only memory as constant values in one or more processor instructions.

In one example, the one or more secrets comprise one or more device attestation keys.

In one example, the processor configured to abort execution of the code stored in execute-only memory if the second control transfer operation is detected at an invalid exit point in the code is further configured to clear the one or more secrets from one or more registers.

In one example, the processor configured to abort execution of the code stored in execute-only memory if the second control transfer operation is detected at an invalid exit point in the code is further configured to generate a fault.

In one example, a valid entry point into the code is identified based on a location of a particular processor instruction in the code.

In one example, a valid exit point of the code is identified based on a location of a particular processor instruction in the code.

In one example, a valid entry point into the code is identified as an offset into a code segment containing the code.

In one example, the first control transfer operation comprises a call instruction or a jump instruction.

In one example, the processor is further configured to: detect a stack pop operation during execution of the code stored in execute-only memory; and clear contents of a memory location retrieved from the stack by the stack pop operation.

In one example, the processor is further configured to clear the contents of the memory location retrieved from the stack by the stack pop operation only if a configuration setting for stack pop operations is enabled.

One or more embodiments may provide a method that comprises: detecting a first control transfer operation; determining that a destination of the first control transfer operation is within code stored in execute-only memory; generating a fault if the destination of the first control transfer operation is an invalid entry point into the code stored in execute-only memory; detecting a second control transfer operation while executing the code stored in execute-only memory; and aborting execution of the code stored in execute-only memory if the second control transfer operation is detected at an invalid exit point in the code.

In one example, a valid entry point into the code is identified based on a location of a particular processor instruction in the code.

What is claimed is:

1. At least one machine accessible storage medium having instructions stored thereon, the instructions when executed on a machine, cause the machine to:
detect a first control transfer operation;
determine that a destination of the first control transfer operation is within code stored in execute-only memory;
generate a fault if the destination of the first control transfer operation is an invalid entry point into the code stored in execute-only memory;
detect a second control transfer operation while executing the code stored in execute-only memory; and
abort execution of the code stored in execute-only memory if the second control transfer operation is detected at an invalid exit point in the code.

2. The storage medium of claim 1, wherein one or more secrets are embedded in the code stored in execute-only memory as constant values in one or more processor instructions.

3. The storage medium of claim 2, wherein the instructions that cause the machine to abort execution of the code stored in execute-only memory if the second control transfer operation is detected at an invalid exit point in the code further cause the machine to clear the one or more secrets from one or more registers.

4. The storage medium of claim 1, wherein a valid entry point into the code is identified based on a location of a particular processor instruction in the code.

5. The storage medium of claim 1, wherein a valid exit point of the code is identified based on a location of a particular processor instruction in the code.

6. The storage medium of claim 1, wherein a valid entry point into the code is identified as an offset into a code segment containing the code.

7. The storage medium of claim 1, wherein the instructions further cause the machine to:
detect a stack pop operation during execution of the code stored in execute-only memory; and
clear contents of a memory location retrieved from the stack by the stack pop operation.

8. An apparatus comprising a processor, wherein the processor is configured to:
detect a first control transfer operation;
determine that a destination of the first control transfer operation is within code stored in execute-only memory;
generate a fault if the destination of the first control transfer operation is an invalid entry point into the code stored in execute-only memory;
detect a second control transfer operation while executing the code stored in execute-only memory; and
abort execution of the code stored in execute-only memory if the second control transfer operation is detected at an invalid exit point in the code.

9. The apparatus of claim 8, wherein one or more secrets are embedded in the code stored in execute-only memory as constant values in one or more processor instructions.

10. The apparatus of claim 9, wherein the one or more secrets comprise one or more device attestation keys.

11. The apparatus of claim 9, wherein the processor configured to abort execution of the code stored in execute-only memory if the second control transfer operation is detected at an invalid exit point in the code is further configured to clear the one or more secrets from one or more registers.

12. The apparatus of claim 8, wherein the processor configured to abort execution of the code stored in execute-only memory if the second control transfer operation is detected at an invalid exit point in the code is further configured to generate a fault.

13. The apparatus of claim 8, wherein a valid entry point into the code is identified based on a location of a particular processor instruction in the code.

14. The apparatus of claim 8, wherein a valid exit point of the code is identified based on a location of a particular processor instruction in the code.

15. The apparatus of claim 8, wherein a valid entry point into the code is identified as an offset into a code segment containing the code.

16. The apparatus of claim 8, wherein the first control transfer operation comprises a call instruction or a jump instruction.

17. The apparatus of claim 8, wherein the processor is further configured to:
detect a stack pop operation during execution of the code stored in execute-only memory; and
clear contents of a memory location retrieved from the stack by the stack pop operation.

18. The apparatus of claim 17, wherein the processor is further configured to clear the contents of the memory location retrieved from the stack by the stack pop operation only if a configuration setting for stack pop operations is enabled.

19. A method, comprising:
detecting a first control transfer operation;
determining that a destination of the first control transfer operation is within code stored in execute-only memory;
generating a fault if the destination of the first control transfer operation is an invalid entry point into the code stored in execute-only memory;
detecting a second control transfer operation while executing the code stored in execute-only memory; and
aborting execution of the code stored in execute-only memory if the second control transfer operation is detected at an invalid exit point in the code.

20. The method of claim 19, wherein a valid entry point into the code is identified based on a location of a particular processor instruction in the code.
